(19) United States
(12) Patent Application Publication
(10) Pub. No.: US 2010/0311022 A1
(43) Pub. Date: Dec. 9, 2010

(54) Runner's Arm Position Training Device

(76) Inventors: Jeffrey Asper, Escondido, CA (US); Aaron I. Anaya, Escondido, CA (US)

Correspondence Address: STEVEN W. WEBB, 825 College Blvd., Suite 102620, Oceanside, CA, 92057, US

(21) Appl. No.: 12/478,777

(22) Filed: Jun. 5, 2009

(51) Int. Cl. G09B 19/00

(52) U.S. Cl. 434/258

(57) ABSTRACT

A runners training device is presented that holds a runners arm in the correct position for correct running form. The invention consists of a short bar made from metal or plastic plus two closeable sleeves that fit over the upper and lower arms. When attached, the bar holds the runners elbows at the correct angle and restrains the elbow during the running exercise.

### FIELD OF THE INVENTION

The present invention relates to the field of recreational and professional athletic training devices.

### BACKGROUND OF THE INVENTION

Runners are trained in current training methods to hold their arms in a characteristic pose alongside their bodies and swing them as they stride. This position is to be maintained during the arm movement associated with running and minimizes aerodynamic drag as well as adding the theoretical maximum to their balance and forward momentum.

The arm position is to hold the elbows such that the upper and lower arms are at a right angle to each other and to keep the arms close to the runner's side during the running exercise. This position can be difficult to hold during a run, and requires a physical restraint to teach the necessary muscle memory.

### SUMMARY OF THE INVENTION

The present invention is a simple mechanism with no moving parts that holds the runners upper and lower arms at the required angle for arm position training. The invention consists of a rigid bar with two sleeves, one at each end. The sleeves position at the end of the bar is at an angle, such that when the wrist and upper arm are fastened into the sleeves the elbow is held at the correct angle for arm position training.

The sleeves are constructed out of a soft material and can be tightened with Velcro™ fasteners on the outer surface of the sleeves.

### BRIEF DESCRIPTION OF THE DRAWINGS

FIG. 1 is a perspective view of the invention

FIG. 2 is a view of the invention worn by a runner

### DESCRIPTION OF THE PREFERRED EMBODIMENT

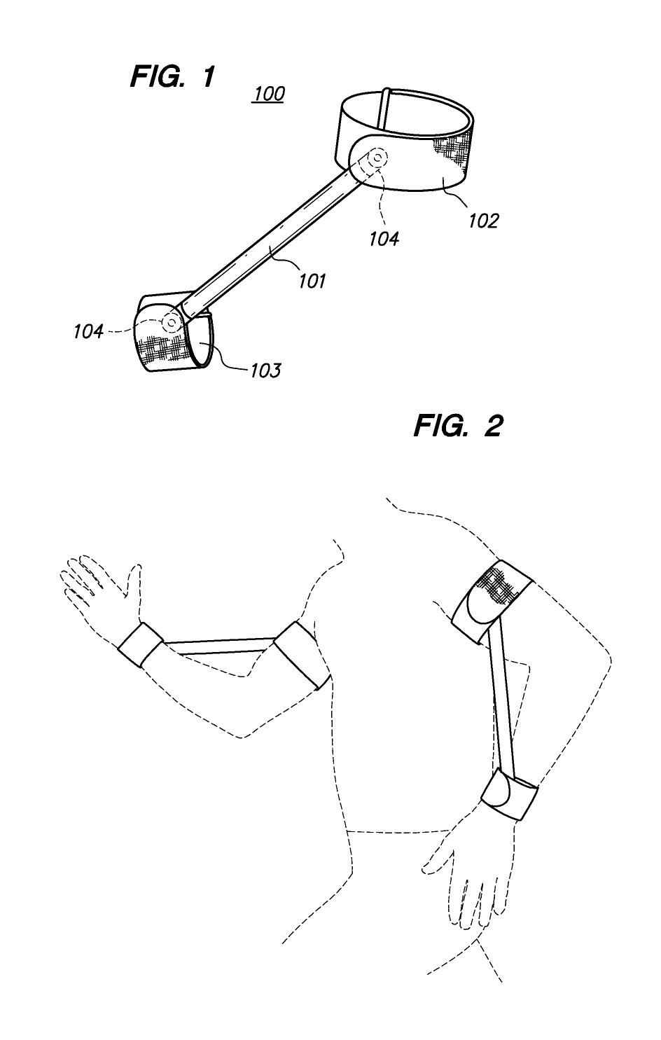

The invention 100 as shown in FIG. 1 is comprised of a restraining bar 101, an upper arm sleeve 102 and a lower arm sleeve 103. The upper arm sleeve 102 and lower arm sleeve 103 are connected in a rotatable manner with the restraining bar 101 by means of two sleeve connection means 104. The sleeves 102,103 are comprised of a semi-rigid or soft material with a hook and loop connection means (not shown) that closes the sleeves 102,103 around the runners arm. The preferred embodiment uses a rigid sleeve with a soft flap containing the hook and loop connection means.

The invention 100 is used by opening up the sleeves 102,103 at the hook and loop connection means, wrapping the lower arm into the lower arm sleeve 102 and the upper arm into the upper arm sleeve 103, as shown in FIG. 2, then closing the hook and loop connection means at both points. The restrained arm is held loosely at the correct angle for running. The same procedure is repeated with another copy of the invention 100 with the other arm.

This invention has other applications, potentially, and one skilled in the art could discover these. The explication of the features of this invention does not limit the claims of this application; other applications developed by those skilled in the art will be included in this invention.

What is claimed is

1. An arm positioning device, the device is comprised of a restraining bar, an upper arm sleeve, and a lower arm sleeve. The restraining bar is comprised of a rigid material, the upper arm sleeve and lower arm sleeve connected in a rotatable manner with the restraining bar by means of two sleeve connection means, the sleeves are comprised of material selected from the list of semi-rigid and soft, with a hook and loop connection means attached to the sleeves.

2. An arm positioning device as in claim 1, the sleeve material comprised of stiff cloth, the restraining bar comprised of metal or plastic.

3. A method of using an arm positioning device as in claim 1, comprised of the steps of
opening up the hook and loop connection means of the lower arm sleeve,
opening up the hook and loop connection means of the upper arm sleeve,
wrapping the upper arm into the upper arm sleeve,
wrapping the lower arm into the lower arm sleeve,
tightening the lower arm sleeve around the lower arm and connecting the hook and loop connection means,
tightening the upper arm sleeve around the upper arm and connecting the hook and loop connection means.
